(19) United States
(12) Patent Application Publication
(10) Pub. No.: US 2005/0265771 A1
(43) Pub. Date: Dec. 1, 2005

(54) Cleaning apparatus

(76) Inventors: Charles Lord, Scottsdale, AZ (US); Jeff Doss, Phoenix, AZ (US); Randal Toltzman, Scottsdale, AZ (US)

Correspondence Address: JACKSON WALKER LLP, 2435 NORTH CENTRAL EXPRESSWAY, SUITE 600, RICHARDSON, TX, 75080, US

(21) Appl. No.: 11/134,635

(22) Filed: May 20, 2005

Related U.S. Application Data
(60) Provisional application No. 60/573,273, filed on May 20, 2004.

(51) Int. Cl. B43K 5/00

(52) U.S. Cl. 401/198; 15/210.1

(57) ABSTRACT

What is disclosed is a cleaning apparatus having a body (100) and stored therein, a micro-fiber cleaning cloth (101).

### CROSS REFERENCE TO RELATED APPLICATION

This application is related to U.S. Provisional Patent Application No. 60/573,273, filed on May 20, 2004, entitled “Cleaning Tool”, the entire contents of which are incorporated herein by this reference. The Applicants hereby claim the benefits of this earlier pending provisional application under 35 U.S.C. Section 119(e).

### FIELD OF THE INVENTION

The present invention relates to cleaning tools and accessories for devices such as personal digital assistants (“PDAs”), mobile telephones, portable computers, calculators, film and digital cameras, MP3 players, and the like.

### BACKGROUND OF THE INVENTION

The market for display-centric mobile devices, such as personal digital assistants, laptop and tablet computers, calculators, mobile telephones, digital cameras and the like continues to grow as the cost and size of these devices decreases and functionality increases. These devices typically have input/output, such information screens, user interfaces, displays, keyboards, writing screens, and the like (collectively, “I/O interfaces”) which are actively used in a variety of contexts. For example, a PDA I/O may be accessed using a stylus, a PDA phone may be placed to the side of the head of a user and a camera screen may be placed proximate the user's head when photographs are taken. Because these I/O interfaces are used in a variety of contexts, there are a variety of ways in which they can become smudged or dirty with grease, dust, dirt and the like, both on display screens and within crevices. What is desired is a compact cleaning apparatus for use with display centric mobile devices that will reach within tight spaces and can be used to clean delicate screens and displays, in either case, without scratching or defacing the device. Further, such a cleaning apparatus would be multi-functional, more convenient than a traditional cloth and permit personalization by the user. The need for such an apparatus would complement conventional accessories for these types of devices, such as screen overlays.

### SUMMARY OF INVENTION

The present invention comprises a cleaning apparatus having a body and stored therein, a micro-fiber cleaning cloth. The present invention will now be described with reference to the following drawings, in which like reference numbers denote the same element throughout.

### BRIEF DESCRIPTION OF THE DRAWINGS

FIG. 1A is a perspective view of a first embodiment of the present invention in the closed position;

FIG. 1B is a perspective view of the first embodiment of the present invention in the open position;

FIG. 1C is a perspective view of the micro-fiber cloth of the present invention dimensioned to fit in the first embodiment of the present invention;

FIG. 1D is a side view of the first embodiment of the present invention showing the placement of the micro-fiber cloth therein;

FIG. 2A is a perspective view of a second embodiment of the present invention in the closed position;

FIG. 2B is another perspective view of the second embodiment of the present invention in the closed position, showing the attached clip feature;

FIG. 2C is another perspective view of the second embodiment of the present invention in the closed position, showing the unattached clip feature;

FIG. 2D is a perspective view of the second embodiment of the present invention with the cap in place;

FIG. 2E is a perspective view of the second embodiment of the present invention with the cap being removed;

FIGS. 2F and 2G are perspective views of the second embodiment of the present invention with the micro-fiber cloth being removed;

FIGS. 2H and 21 are perspective views of another aspect of the second embodiment of the present invention;

FIG. 3A is a perspective view of a third embodiment of the present invention;

FIG. 3B is another perspective view of the third embodiment of the present invention with the cloth portion being removed;

FIG. 3C is view of the bone structure of the third embodiment of the present invention;

FIG. 3D is a another perspective view of the third embodiment of the present invention;

FIG. 3E is a perspective view of the third embodiment of the present invention in use;

FIG. 3F is a view of the third embodiment of the present invention in use;

FIG. 3G is a perspective view of the third embodiment of the present invention in use;

FIG. 3H is a perspective view of the use of the detail tool stored within the third embodiment of the present invention;

FIGS. 31-3K illustrates storage options for the third embodiment of the present invention in use;

### DETAILED DESCRIPTION OF THE PRESENT INVENTION

The present invention comprises a cleaning apparatus for use with, among other things, display centric mobile devices.

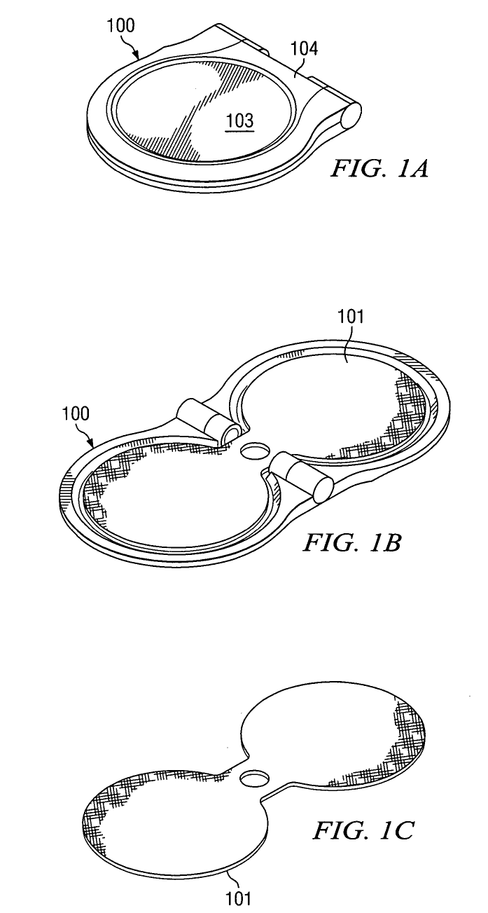

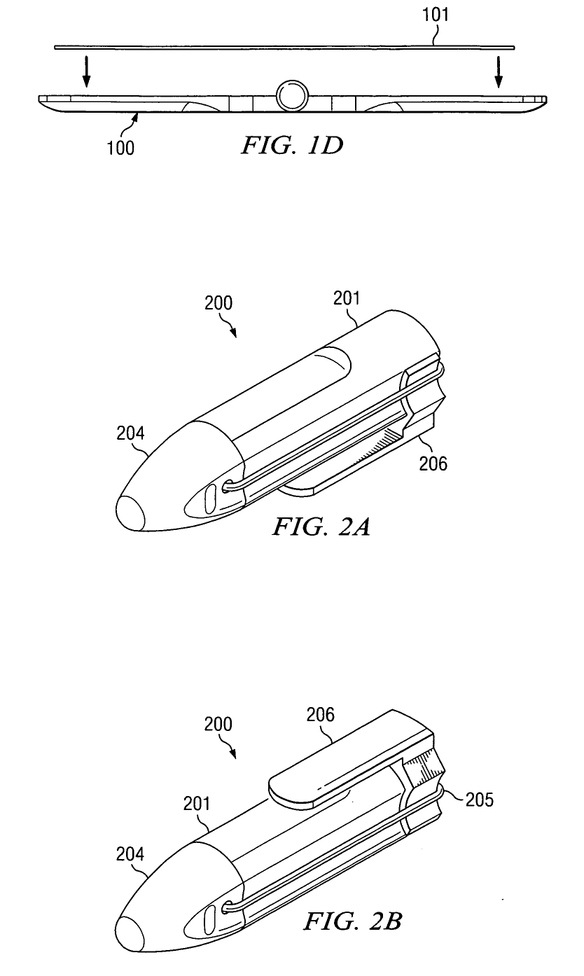

A first embodiment of the present invention, as seen in FIGS. 1A-1C, comprises a cleaning apparatus having a circular, compact design. FIG. 1A is a perspective view of compact case 100 in the closed position. FIG. 1B shows compact case 100 in the open position, with micro-fiber cloth 101 located therein. As seen in FIG. 1C, micro-fiber cloth 101 is dimensioned to fit within the contours of compact case 100. Compact case 100 has a slim, circular dimension, adapted to hold therein interchangeable cleaning pads or cloth 101. The cloth 101 is visible within the compact case 101 as the case 100 has a clear or translucent front lens 103. The cloth can be made of any material, including micro-fiber material, which does not deface or scratch displays. As seen in FIG. 1A, the first embodiment can have a variety of aesthetic features, such as a chrome bezel 104, and a variety of different colors and patterns for the compact case and the cleaning pads or cloths.

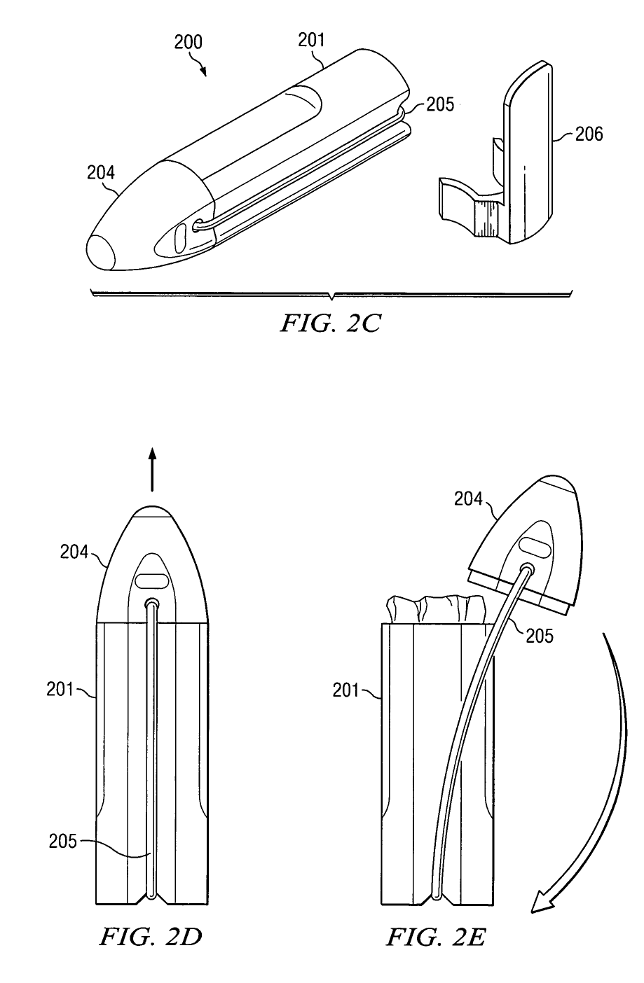

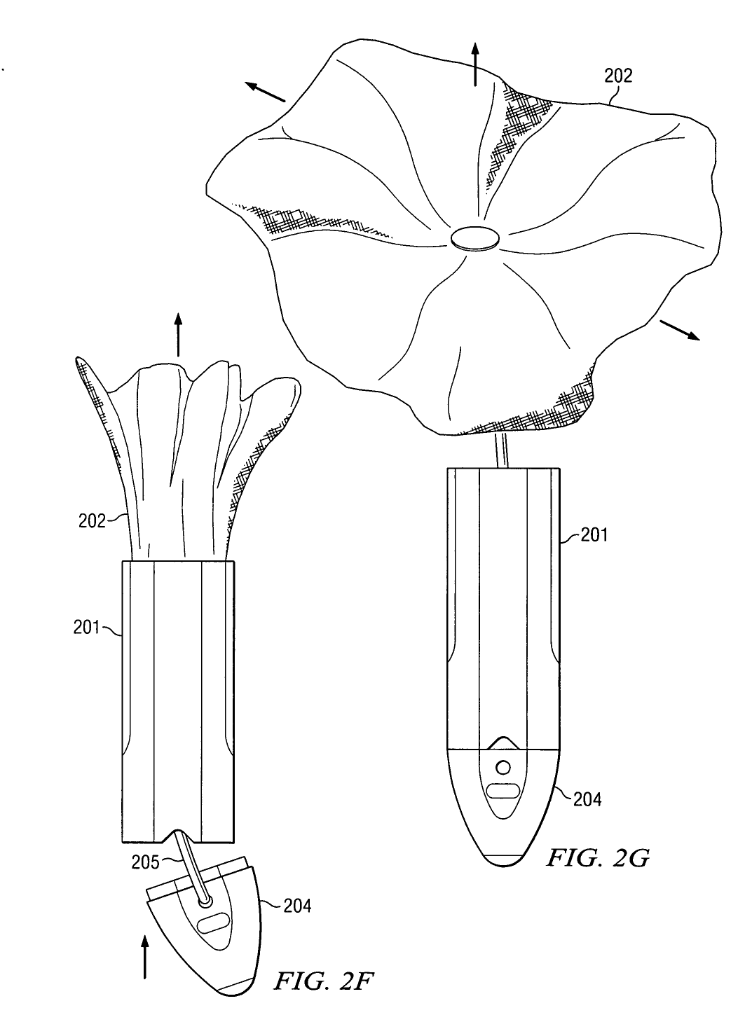

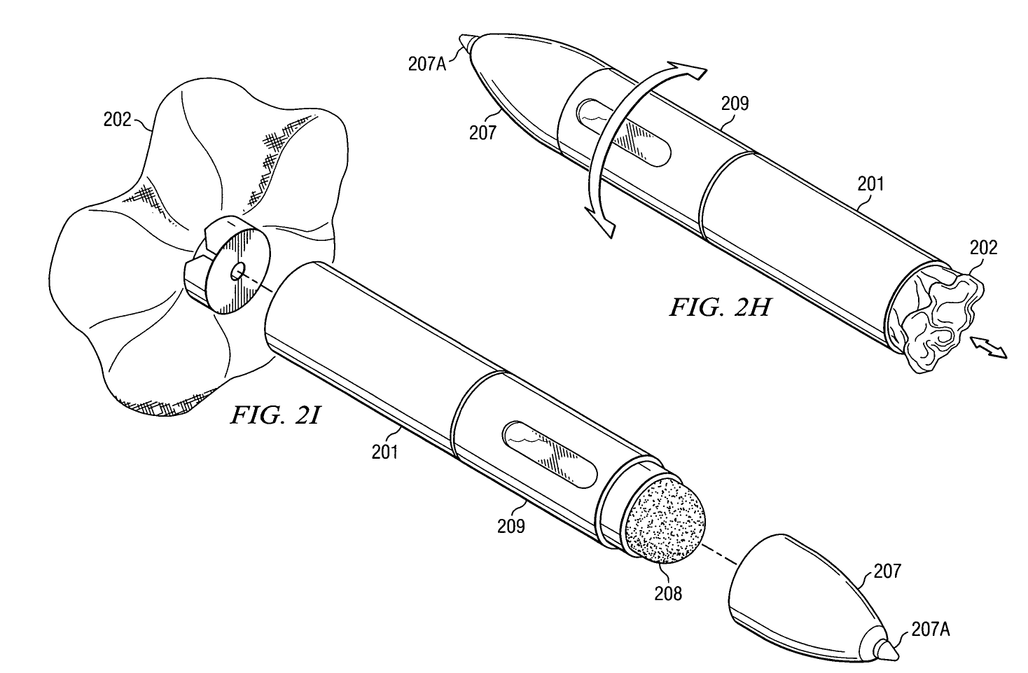

A second embodiment of the present invention is seen in FIGS. 2A-2G. As seen in FIG. 2A, cleaning apparatus 200 comprises cylindrical body 201 with enclosed cleaning cloth 202 made with a micro-fiber material. The cylinder body 201 has a top end 202 and a bottom end 203, the top end 202 having cap 204 thereon, said cap 204 being removably coupled to the cylinder body 201, and being attached thereto with a non-rigid material, such as an elastic filament, twine, string, rope or cord 205. The elastic filament, twine, string, rope or cord 205 is operable to maintain the cap on the cylinder body 201, however, is flexible such that the cap 204 can be removed from the cylinder body 201 so as to allow the cleaning cloth 202 to be extracted therefrom. As seen in FIGS. 2B and 2C, along a side of the cylinder body 201 can be coupled a clip 206 to provide a user to clip the cleaning apparatus on a belt, car visor, and such. Cylindrical body 201 comprises an over-mold section which can have a high polished finish. FIG. 2B is another perspective view of the cleaning apparatus 200 in the closed position, showing clip 206 attached. FIG. 2C shows the cleaning apparatus 200 in the closed position with clip 206 unattached. FIG. 2D is a perspective view of cleaning apparatus 200 with the cap in place. FIG. 2E shows cleaning apparatus 200 with cap 204 being removed, although remaining attached to the cylindrical body 201 by elastic filament, twine, string, rope or cord 205. FIGS. 2F and 2G are perspective views of cleaning apparatus 200 with micro-fiber cloth 202 being removed and expanded for use. FIGS. 2H and 21 illustrate another aspect of the second embodiment of the present invention in which a micro-fiber cloth 202 is exposed by twisting a middle portion of the cylindrical body 201. As seen in Figure By exposing only a portion of cloth 202, cloth 202 can be used as a brush. As seen in FIG. 2I, a cap 207 can be included at one end of cylindrical body 201, said cap 207 having located at the tip thereof a PDA stylus tip 207A. Such stylus tip can be fabricated of a rubber and formed so as t permit it to reach within crevices and cracks. Also, cylindrical body 201 can have a damp tip 208 operable to wick liquid from a reservoir 209. The reservoir may include a window so that the user can observe the amount of liquid within the reservoir. In this aspect, micro-fiber cloth can be entirely removed from the end opposite the damp tip.

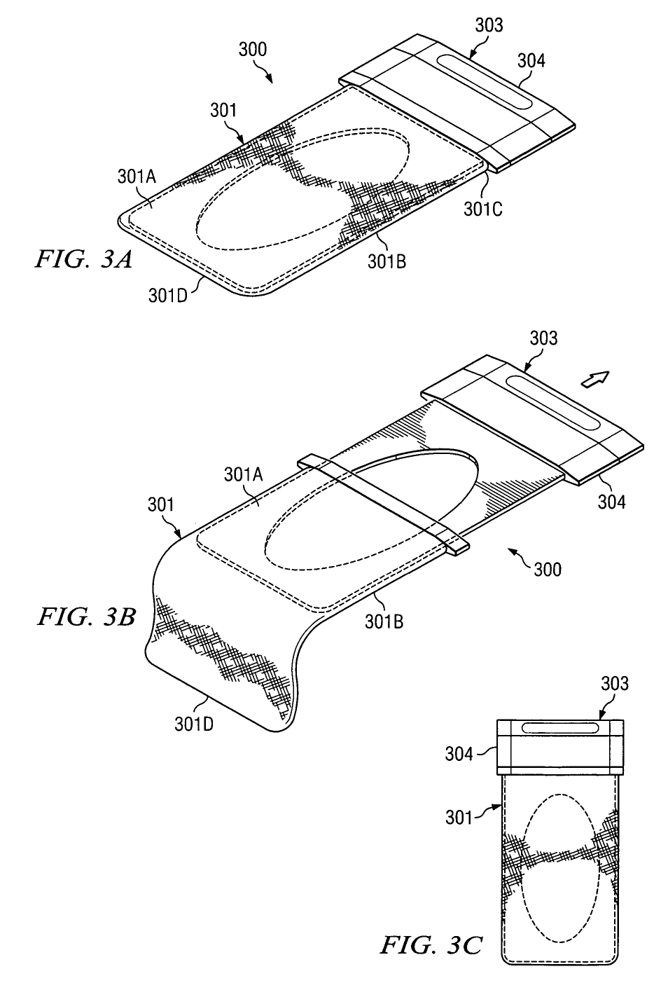

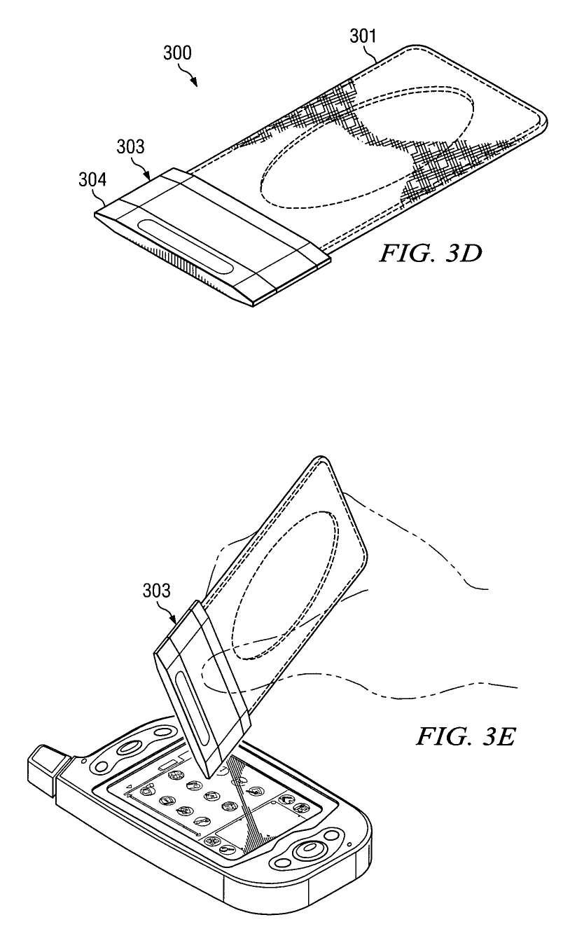

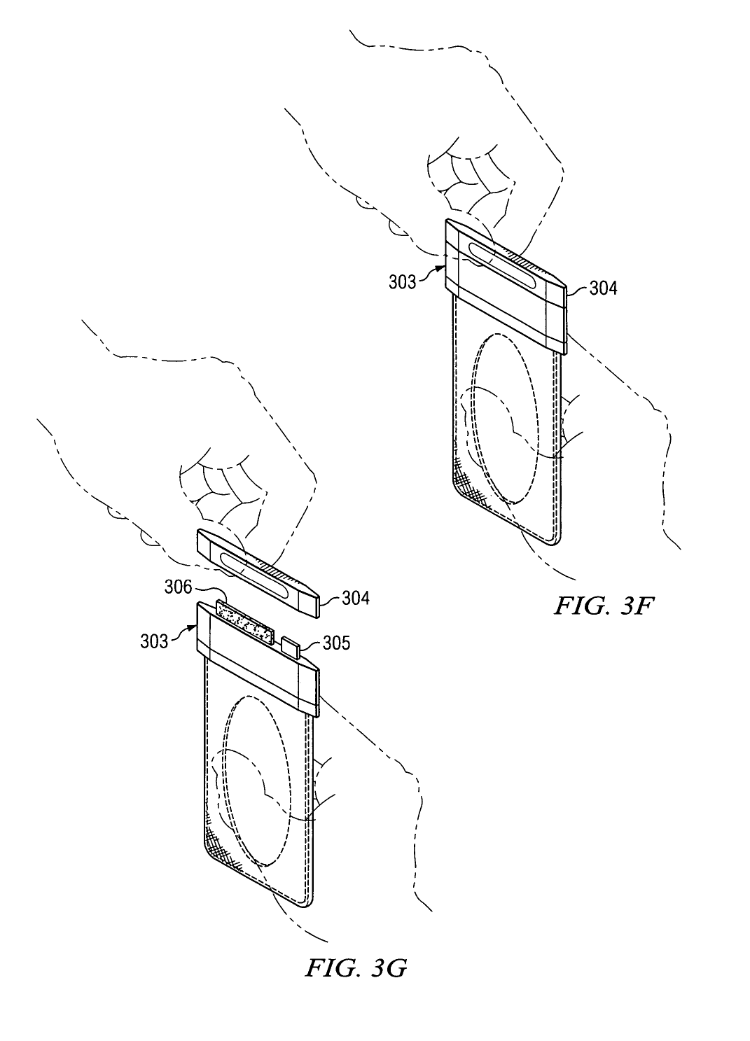

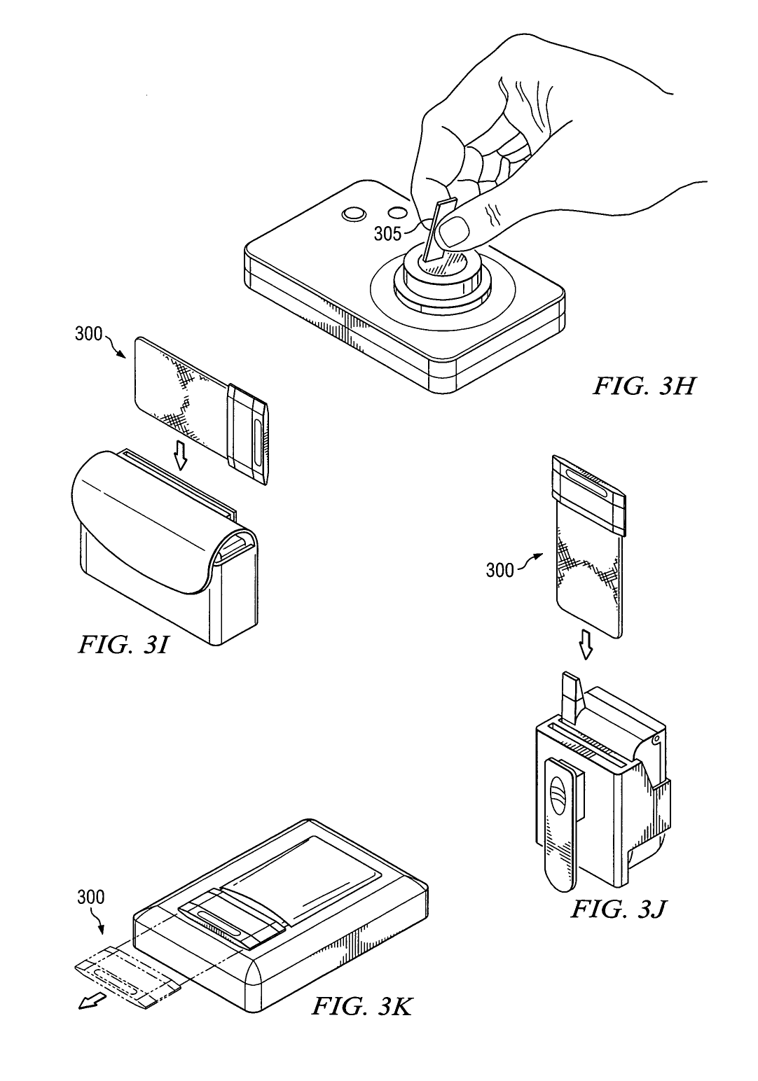

A third embodiment of the present invention, as seen in FIGS. 3A-3K, comprises a mobile phone centric design. The third embodiment of the present invention is credit card sized, wafer thin and dimensioned to fit into or integrate with a phone holder.

Referring now to FIG. 3A, a one sided micro-fiber cloth 301, having a first side end 301A and second side end 301B and a top end 301C and bottom end 301D, is folded such that the first end 301A and the second end 301B are adjacent. The first end 301A is then coupled to the second end 301B and the bottom end 301D is closed so as to provide a pocket in which bone structure 303 can be inserted and removed as seen in FIG. 3B. The pocketed cloth is dimensioned to fit over bone structure 303. Bone structure 303 is made of plastic, rigid rubber or the like. As seen in FIG. 3C, bone structure 303 can have formed therein a hollow center. This third embodiment of the present invention is thin so as to be integrated into a mobile phone holder or clip or PDA holder as seen in FIGS. 31, 3J and 3K. Referring to FIG. 3B, in operation, the cloth 301 slides off the bone structure 303 for use as standard cloth. As seen in FIG. 3C, the hollow center enables the user to maintain the cloth on the bone structure while cleaning, the cleaning apparatus being operable to flex. As seen in FIGS. 3F-3H, the upper portion of bone structure 303 comprises a removable cap 304. Contained therein is a removable detail tool 305 for cleaning between keys and buttons as well as camera lens as seen in FIG. 3H. The tool can be fabricated from a resilient rubber material Such a material has a variety of benefits when used in combination with the third embodiment of the present invention. For example, the residue of the rubber material can provide a protective barrier. A silicon rubber blade lays down a microscopic layer of silicone, which acts to repel grime, dust and moisture. Such a material is also resists scratching delicate surfaces. Such a material can be shaped to reach into small places, such as in between keys and within crevices. A rubber tip coupled to the present invention can be used to reach dirt and grime in small places. Also, as seen therein is a sponge material 306 operable to wick cleaning fluid contained within a reservoir (not shown) within the upper portion of the bone structure.

Referring again to FIGS. 3I-3K, a variety of storage options for the third embodiment of the present invention are shown. For example, as seen in FIG. 3I, a credit card sized cleaning apparatus can be adapted to be held in the back of universal phone holder. In FIG. 3J, a credit card sized cleaning apparatus can be slide into back of phone specific plastic clip style holder. As seen in FIG. 3K, the cleaning apparatus can be stored in the back of a PDA with an adhesive sleeve.

Each embodiment of the present invention permits product customization and personalization. For example, the cases of each embodiment can include thereon logos, photographs, name imprints, prints, or monograms. The present invention is adapted to be provided in components that can be mixed and matched. For example, with the compact case embodiment, a user can select the desired color for the compact body and micro-fiber pads.

The apparatus and embodiments shown and described above are only exemplary. Even though several characteristics and advantages of the present invention have been set forth in the foregoing description together with details of the invention, the disclosure is illustrative only and changes may be made within the principles of the invention to the full extent indicated by the broad general meaning of the terms used in herein and in the attached claims. For example,

1. A cleaning apparatus adapted to clean devices, including display centric mobile devices such as PDAs, cell phones MP3 players, computers and the like.

2. A cleaning apparatus comprising a circular, compact case having a micro-fiber cloth dimensioned to fit within the contours of the compact case.

3. The cleaning apparatus of claim 2, further comprising the compact case having a clear or translucent front lens within a bezel.

4. The cleaning apparatus of claim 2, further comprising being adapted to having individual components thereof interchangeable.

5. The cleaning apparatus of claim 2, in combination with a mobile device.

6. A cleaning apparatus, comprising a cylindrical body with an enclosed micro-fiber cloth.

7. The cleaning apparatus of claim 6, further comprising:
a top end;
a bottom end; and
a cap removably coupled to the top end.

8. The cleaning apparatus of claim 7, further comprising the cap being attached to the cylindrical body thereto with a non-rigid material.

9. The cleaning apparatus of claim 8, wherein the non-rigid material comprises an elastic filament, twine, string, rope or cord.

10. The cleaning apparatus of claim 7, further comprising a clip coupled longitudinally along the side of the cylindrical case.

11. The cleaning apparatus of claim 7, further comprising a mechanism for exposing the micro-fiber cloth by twisting a portion of the cylindrical body.

12. The cleaning apparatus of claim 7, further comprising a cap being removably coupled to an end of the cylindrical body.

13. The cleaning apparatus of claim 12, further comprising the cap having located at the end thereof a PDA stylus tip.

14. The cleaning apparatus of claim 13, wherein the stylus tip is fabricated of a resilient rubber and formed so as to permit it to reach within crevices and cracks.

15. The cleaning apparatus of claim 13, further comprising:
a damp tip located at an end of the cylindrical body;
a reservoir within the cylindrical body operable to hold fluid; and
the damp tip operable to wick liquid from the reservoir.

16. The cleaning apparatus of claim 6, in combination with a mobile device.

17. A cleaning apparatus, comprising a bone structure having a micro-fiber cloth disposed thereon.

18. The cleaning apparatus of claim 17, wherein the micro-fiber cloth has a first side end, a second side end a top end and bottom end;
said micro-fiber cloth being folded such that the first side end and the second side end are coupled; and
the bottom end being closed so as to provide a pocket in which the bone structure can be inserted and removed.

19. The cleaning apparatus of claim 18, wherein the micro-fiber cloth is dimensioned to fit over the bone structure.

20. The cleaning apparatus of claim 19, further comprising the bone structure being made of plastic or rigid rubber.

21. The cleaning apparatus of claim 17, further comprising a removable detail tool being located within the top portion of the bone structure.

22. The cleaning apparatus of claim 21, wherein the detail tool is made of a resilient rubber material.

23. The cleaning apparatus of claim 21, further comprising a sponge material located at the end of the bone structure;
a reservoir located within the bone structure; and
the sponge material operable to wick cleaning fluid contained within the reservoir.

24. The cleaning apparatus of claim 17, in combination with a mobile device.
